(19) United States
(12) Patent Application Publication
(10) Pub. No.: US 2005/0161475 A1
(43) Pub. Date: Jul. 28, 2005

(54) One-handed manipulation tool for pump-assisted liquid container

(76) Inventor: Matomi Kaga, Oita Ken (JP)

Correspondence Address: KUBOVCIK & KUBOVCIK, SUITE 710, 900 17TH STREET NW, WASHINGTON, DC, 20006, US

(21) Appl. No.: 11/038,428

(22) Filed: Jan. 21, 2005

(30) Foreign Application Priority Data
Jan. 22, 2004 (JP) 2004-014892

(51) Int. Cl. G01F 11/06; G01F 11/30; G01F 11/36; G01F 11/42; B65D 88/54

(52) U.S. Cl. 222/321.7

(57) ABSTRACT

A one-handed manipulation tool of a cap type is fitted on and fixed to a head portion of a dispenser pump. The one-handed manipulation tool includes a push base and a ceiling portion vertically separated from each other and coupled to each other by two stays to thereby define an insertion space for a finger between them. It is possible to push the head portion of the pump by an inserted finger of a hand, and to simultaneously receive a liquid from a pump nozzle by a palm of the hand. It provides an improved pump manipulation ability in case of one-handed usage, allows for a plurality of orientations of fingertips relative to a pump at this time, and eliminates a changeover manipulation of a nozzle in case of changeover to a two-handed style or a one-handed style which has been required in the conventional way.

### DETAILED DESCRIPTION OF THE INVENTION

1. Technical Field of the Invention

The present invention relates to a one-handed manipulation tool for a pump-assisted liquid container, and particularly to a one-handed manipulation tool for a pump-assisted liquid container, which allows for, by one hand, simultaneous execution of both a pumping manipulation for pushing down a head portion of a dispenser pump to dispense a liquid within the container from a nozzle, and a liquid receiving manipulation for receiving the liquid dispensed from the nozzle by a palm of the hand.

2Related Art

There have been recently developed liquid containers having one-push type of simple dispenser pumps fitted to mouths of the containers, respectively, as ones for containing therein shampoo, cosmetic milky lotion, or the like. The dispenser pumps are cylinder types.

In usage of each of them, the head portion of the dispenser pump is pushed down against a spring force of a spring within the cylinder, by one hand,. This lowers a piston within the cylinder so that a liquid within the container is updrawn through an updrawing tube communicated with the cylinder and then dispensed from an outlet of a nozzle protruded from a peripheral side surface of the head portion. After dispensed, the liquid may be received by a palm of the other hand, simultaneously with the pushing.

In the pump-assisted liquid container configured in this way, it is required to receive the liquid by the other hand while pushing down the head portion by one hand, thereby causing inconvenience of usage of both hands. It has been thus difficult to use the pump-assisted liquid container, for a physically handicapped person who can use only one hand, for example.

As a conventional technique for solving it, there has been known a pump-assisted liquid container having a one-hand manipulation function, from a patent-related reference 1.

The pump-assisted liquid container of the patent-related reference 1 has a nozzle fitted to a head portion in a manner that the nozzle can be turned about its axis intersecting an axis of an updrawing tube at an angle of about 45 degrees, and the container has such a structure that the nozzle has an outlet which can be located above the head portion when the nozzle is turned.

Thus, in using the pump, the nozzle is firstly turned by about 180 degrees such that the outlet is located above the head portion. Thereafter, a palm of one hand is directed upwardly, and the nozzle is clamped by and between two fingers of the hand. At this time, the nozzle has its tip portion in a state upwardly protruded between the clamping fingers. Next, the head portion is pushed down by a back of the hand, while keeping the above state. This causes a liquid within the container to be dispensed from the outlet of the nozzle. After dispensed, the liquid is received by the upwardly directed palm.

It is possible for the pump-assisted liquid container, to be used in a conventional manner by using both hands. In that case, the nozzle is turned back within a vertical plane such that the outlet is located below the head portion. This allows for usage by both hands in a normal manner.

[Patent-Related Reference 1] JP-A-2002-205758

However, in one hand usage of the pump-assisted liquid container of the patent-related reference 1, it is required to clamp the upwardly directed nozzle by and between two fingers and to push down the head portion of the dispenser pump by the back of the hand, while keeping the above state. This leads to an unstable pushing down manipulation for the pump. Thus, if the pushing down direction of the head portion is slightly deviated from a vertical direction in a state that the amount of the liquid within the container is reduced, the container is likely to be wobbled or even tumbled in the course of pushing down.

Moreover, to push down the head portion by the back of the hand while clamping the nozzle by and between two fingers in the above manner, the orientation of fingertips relative to the pump is restricted to one direction. As a result, when one hand is stretched to the container so as to dispense the liquid and the orientation of two fingers is different from an orientation of the nozzle in a circumferential direction of the head portion, it is required to horizontally turn the nozzle about an axis of the head portion (i.e., an axis of the updrawing tube) to thereby match the longitudinal orientation of the nozzle with the orientation of the fingers.

Incidentally, the dispenser pump may be arbitrarily changed over to a two-handed style or a one-handed style. However, it is required to pinch the nozzle by fingertips and to turn the nozzle by about 180 degrees, in conducting such a changeover. This complicates a pumping manipulation.

### SUMMARY OF THE INVENTION

It is therefore an object of the present invention to provide a one-handed manipulation tool for a pump-assisted liquid container, which provides an improved pumping manipulation ability in case of one-handed usage, allows for a plurality of orientations of fingertips relative to a pump in case of one-handed usage, and eliminates a changeover manipulation in case of changeover to a two-handed style or a one-handed style.

It is another object of the present invention to provide a one-handed manipulation tool for a pump-assisted liquid container, which can be readily fitted to a head portion.

It is a further object of the present invention to provide a one-handed manipulation tool for a pump-assisted liquid container, by which an orientation of an axial direction of an insertion space for a finger can be changed to a direction where a finger is easily inserted into the insertion space.

The first invention developed for this purpose resides in a one-handed manipulation tool for a pump-assisted liquid container, fitted on a head portion of a dispenser pump for dispensing a predetermined amount of liquid contained within the container, to thereby allow for, by one hand, simultaneous execution of both a pumping manipulation of the dispenser pump, and a liquid receiving manipulation for receiving the liquid dispensed from a nozzle protruded from the head portion by a palm of the hand,
wherein the one-handed manipulation tool comprises:
a fixture member having an outer peripheral plate formed with: an engagement portion for engaging with the head portion; and a cut-out through which the nozzle is inserted; at portions of the outer peripheral plate, respectively;
a push base fixed to the head portion through the fixture member;
one or more stays erected from the push base; and
a ceiling portion provided at tip portions of the stays to define an insertion space for a finger between the ceiling portion and the push base cooperatively with the stays.

According to the first invention, inserted into the insertion space is a finger of one hand upon usage of the pump, and the push base is pushed down together with the head portion by the finger to thereby dispense a liquid from the nozzle. This improves a manipulation ability of the pump upon usage by one hand, as compared with the conventional one-handed manipulation tool in which a nozzle is clamped by and between two fingers and a head portion is pushed down by a palm, for example. Further, there is eliminated the necessity of a changeover manipulation in case of changeover to a two-handed style or a one-handed style, unlike the conventional.

Moreover, the insertion space for a finger is configured to be defined by erecting the stays between the push base and the ceiling portion. In this way, the stays having cross-sectional areas smaller than wall-like segments are utilized as the structures for defining the insertion space, to allow for definition of the insertion space larger than utilizing wall-like segments.

Furthermore, usage of the stay(s) provides a plurality of insertion openings (in case of a plurality of stays) for inserting a finger into the insertion space, or there is provided a larger opening area even when a sole insertion opening is provided (in case of one stay). This allows an orientation of a fingertip relative to the pump to be increased to plural, without limited to one.

Further, the nozzle is inserted through the cut-out and the engagement portion is engaged with the head portion, to fix the fixture member of the cap type to the head portion. This allows the one-handed manipulation tool to be readily fitted on the head portion. As a result, the one-handed manipulation tool is detached from the head portion and can be reused, when the liquid within the container is exhausted.

Materials for the container are not restricted. For example, it is possible to adopt various synthetic resins, various metals, various woods, and various ceramics.

Shapes of the container are not restricted. It is possible to adopt a cylindrical column shape, rectangular column shape, and the like, for example.

Sizes of the container are not restricted as well.

Types of liquids are not restricted. It is possible to adopt various liquid detergents, various cosmetic liquids, and the like, for example.

Structures of the dispenser pump are not restricted. For example, it is possible to adopt a cylinder type which internally includes a spring for pushing back a head portion. It is essential to have a structure capable of dispensing a predetermined amount of liquid within a container from a nozzle, by pushing a head portion into the container.

Structures and sizes of the one-handed manipulation tool are appropriately varied correspondingly to shapes and sizes of head portions of dispenser pumps to which the one-handed manipulation tool is fitted.

Fixing manners of the push base to head portions by the fixture member are not restricted. For example, it is possible to adopt engaging (including gripping), threaded engaging, fusing, welding, and the like. The fixture member detachable from head portions facilitates reuse of the one-handed manipulation tool.

Materials of the fixture member, push base, ceiling portion, and stays are not restricted, respectively. It is exemplarily possible to adopt various synthetic resins, various metals, various woods, and various ceramics.

Shapes of the push base and ceiling portion in plan view are not restricted. For example, it is possible to adopt circular shapes, elliptical shapes, and polygonal shapes including triangular shapes.

To an upper surface of the push base, i.e., to a surface with which a finger contacts upon pumping manipulation, it is possible to apply various embossing, or to adhere an antislipping sheet including a surface having such embossing applied thereto. It is further possible to form an antislipping portion such as projections at a part of an upper surface of the push base. Furthermore, it is possible to form concaves at an upper surface portion of a push base.

Shapes of cross-sections of the stays in a direction orthogonal to longitudinal directions thereof are not restricted. For example, it is possible to adopt circular shapes, elliptical shapes, and polygonal shapes including triangular shapes. Other stay shapes may include remainders present at both sides of a column body, respectively, having a lower side and an upper side corresponding to the push base and the ceiling portion, respectively, when the column body is formed with a through-hole drilled through the column body in a manner that the through-hole has an axis orthogonal to an axis of the column body. Additional arbitrary shapes will do.

Thicknesses of the stays are not limited.

Numbers of the stays to be used are not limited. One will do. Further, two, three or more will do. Only, in case of adopting multiple stays, it is required to define insertion openings through which fingers are inserted, at two or more of locations between the stays, respectively.

To insert a finger into the insertion space, it is preferable that each insertion opening defined between adjacent stays is set at a size where a thumb of a man is insertable. However, it is not limited thereto. For example, it may be set at a size which allows for loose insertion of one or more of little finger, index finger, middle finger, and ring finger.

The second invention resides in the one-handed manipulation tool for a pump-assisted liquid container of the first invention, wherein the push base is configured to be turnable relative to the fixture member, about an axis of an updrawing tube for updrawing the liquid within the container up to the head portion.

According to the second invention, the push base is turned by an appropriate angle about an axis of the updrawing tube, in a situation where it is difficult for a finger to be inserted into the insertion space due to a reason of insertion angle of the finger relative to an axial direction of the insertion space upon usage of the pump by two hands or one hand. This allows an orientation of the axial direction of the insertion space for a finger, to be changed to a direction for facilitating insertion of the finger into the insertion space.

Structures for causing the push base to be turnable relative to the fixture member are not restricted. For example, it is possible to turnably couple one end of a turning pin having the other end fixed to the push base, to the fixture member. Alternatively, it is possible to turnably couple one end of a turning pin having the other end fixed to the fixture member, to the push base. Further, it is possible to turnably couple one end of a turning pin having the other end turnably coupled to the fixture member, to the push base.

According to the first invention, it has a structure that the separated push base and ceiling portion are coupled by one or more stays, thereby providing an improved pump manipulation ability in case of one-handed usage, allowing for a plurality of orientations of fingertips relative to a pump in case of one-handed usage, and eliminating a changeover manipulation of a nozzle in case of changeover to a two-handed style or a one-handed style which has been required in the conventional way.

Further, the fixture member is of a cap type including the engagement portion and cut-out provided at portions of the outer peripheral plate, respectively, thereby allowing the one-handed manipulation tool to be readily attached to and detached from the head portion. In this way, the one-handed manipulation tool is detached from the head portion and can be reused, when the liquid within the container is exhausted.

Moreover, according to the second invention, the push base is fixed to the fixture member in a manner to be turnable about the axis of the updrawing tube, whereby an orientation of an axial direction of the insertion space for a finger can be changed to a direction where a finger is easily inserted into the insertion space.

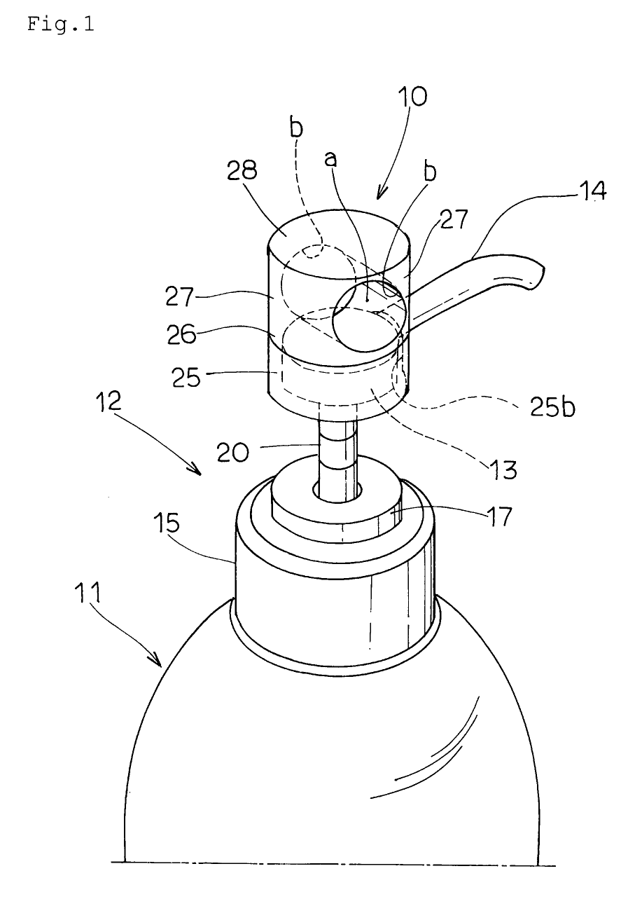

### BRIEF DESCRIPTION OF THE DRAWINGS

[FIG. 1]

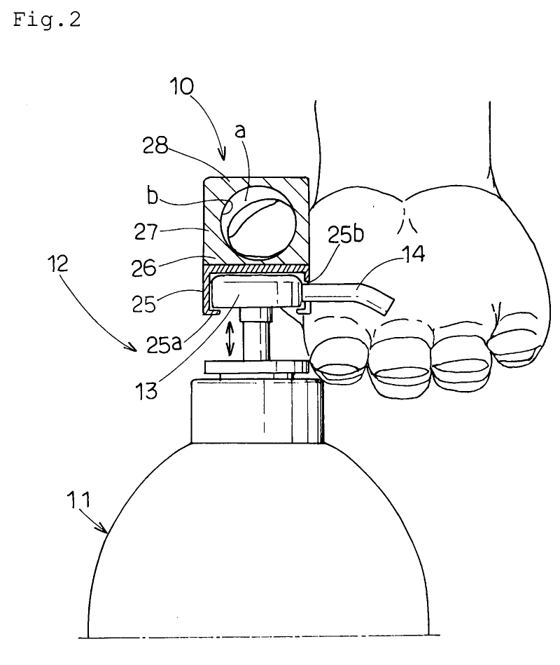

A perspective view of an essential part of a one-handed manipulation tool for a pump-assisted liquid container according to an embodiment 1 of the present invention.

[FIG. 2]

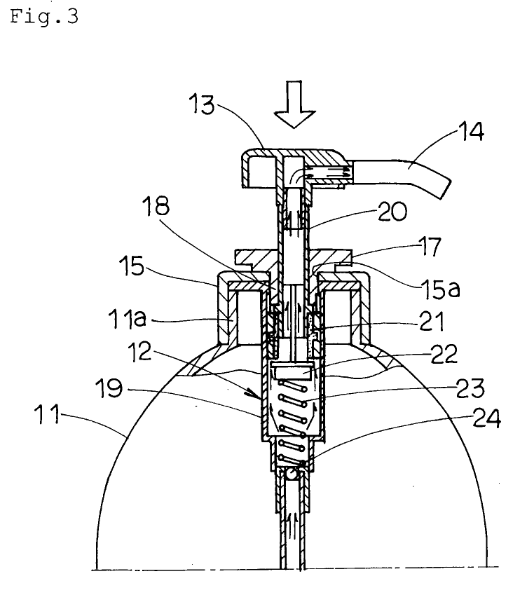

A front view including a partial cross-sectional view of a usage state of the one-handed manipulation tool for a pump-assisted liquid container according to the embodiment 1 of the present invention.

[FIG. 3]

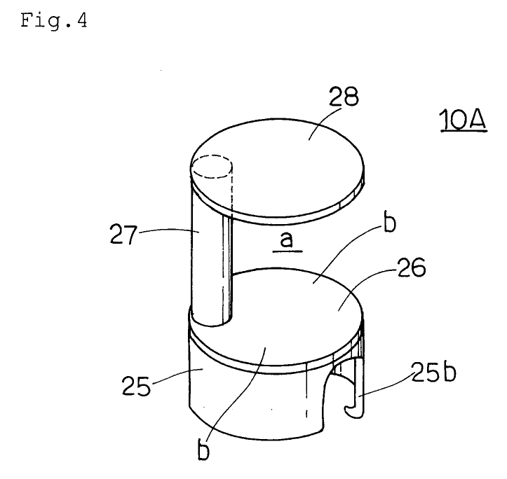

A cross-sectional view of the essential part of the pump-assisted liquid container according to the embodiment 1 of the present invention.

[FIG. 4]

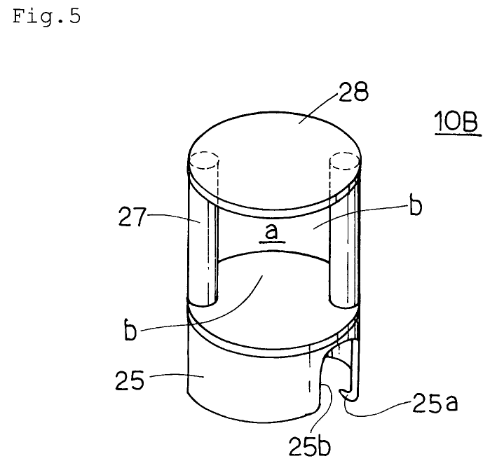

A perspective view of a one-handed manipulation tool having one stay, according to another embodiment of the present invention.

[FIG. 5]

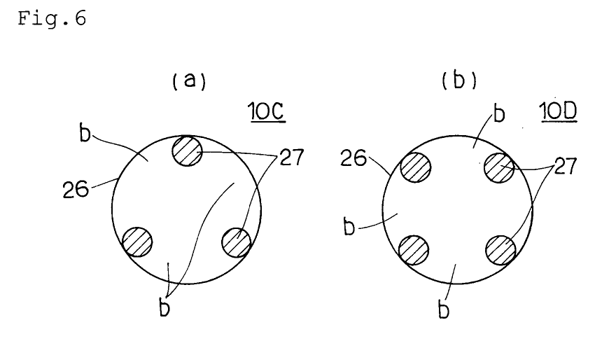

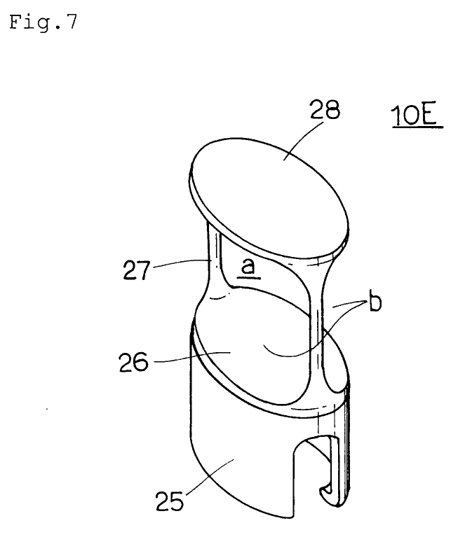

A perspective view of a one-handed manipulation tool having two stays, according to yet another embodiment of the present invention.

[FIG. 6](a) is a transverse cross-sectional view of a one-handed manipulation tool having three stays according to still another embodiment of the present invention, and (b) is a transverse cross-sectional view of a one-handed manipulation tool having four stays according to yet still another embodiment of the present invention.

[FIG. 7]

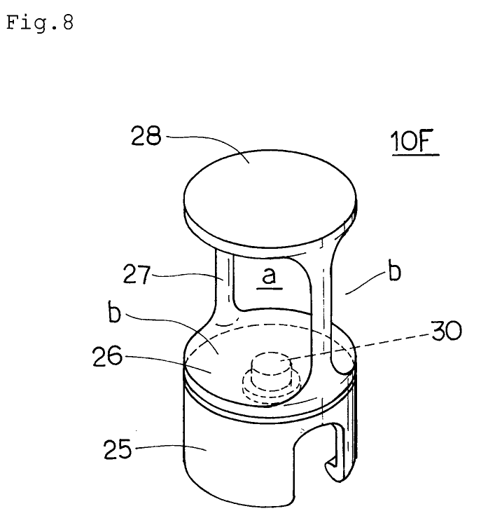

A perspective view of a one-handed manipulation tool having two thin stays, according to a further embodiment of the present invention.

[FIG. 8]

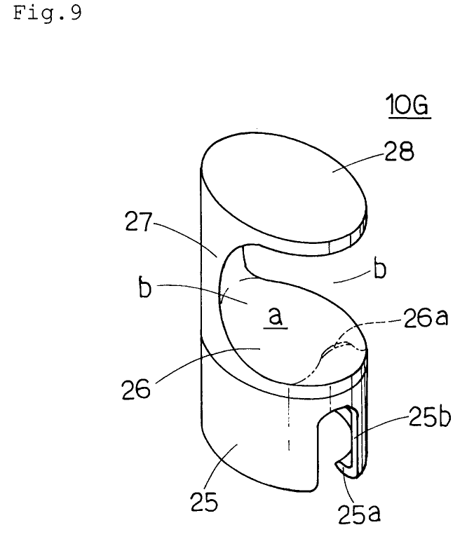

A perspective view of a one-handed manipulation tool having two thin stays and a turnably provided push base, according to a yet further embodiment of the present invention.

[FIG. 9]

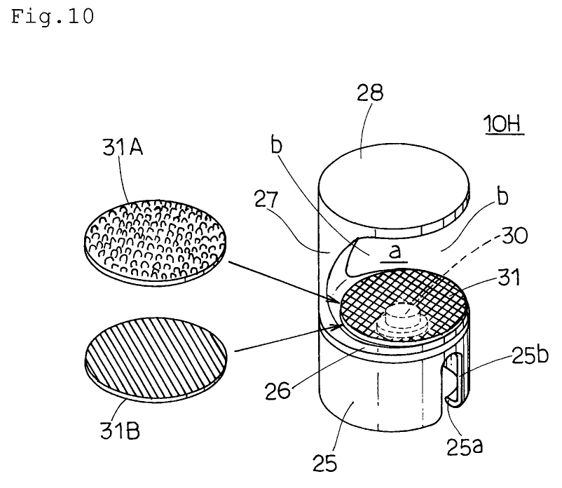

A perspective view of a one-handed manipulation tool having one stay, according to a still further embodiment of the present invention.

[FIG. 10]

A perspective view of a one-handed manipulation tool having one stay and a turnably provided push base, according to a yet still further embodiment of the present invention.

### BEST MODE FOR CARRYING OUT THE INVENTION

The present invention will be described with reference to embodiments thereof. Herein, there will be exemplarily described a one-handed manipulation tool for a pump-assisted liquid container for containing shampoo therein.

### Embodiment 1

In FIG. 1 through FIG. 10, reference numeral 10 designates a one-handed manipulation tool for a pump-assisted liquid container (hereinafter simply called “one-handed manipulation tool”) according to an embodiment 1 of the present invention. This one-handed manipulation tool 10 is fitted onto a head portion 13 of a dispenser pump 12 for dispensing, by one push, a predetermined amount of shampoo liquid (liquid) contained within a container 11 of a predetermined volume. Further, this one-handed manipulation tool 10 has a structure for enabling, by one hand, simultaneous execution of both a pumping manipulation (pushing manipulation) of the dispenser pump 12, and a liquid receiving manipulation for receiving the shampoo liquid dispensed from a nozzle 14 protruded from the head portion 13 by a palm.

Firstly, the container 11 will be explained in detail with reference to FIG. 3.

The container 11 is in a cylindrical bottle shape made of synthetic resin, and has an upper portion gradually reduced in diameter and having an upper end integrally formed with a mouth 11a. Threaded on the mouth 11a is a lid 15 in a bottomed cylindrical shape. The lid 15 has an upper surface formed with a through-hole 15a at a center thereof, and the dispenser pump 12 for updrawing the shampoo liquid within the container 11 has an upper end portion fixed to the lid 15 through the formed portion of the through-hole 15a.

The dispenser pump 12 comprises: an upper ring 17 rotatably inserted through the through-hole 15a of the lid 15; an insertion tube segment 18 integrally formed at a central lower side of the upper ring 17; a cylinder 19 having an upper end portion into which the insertion tube segment 18 is fitted; an updrawing tube 20 for updrawing the shampoo liquid, having an upper portion arranged to be upwardly protruded beyond the upper ring 17, and a base portion fitted in the cylinder 19 through an interior space of the upper ring 17, so as to be movable in an axial direction of the cylinder; the head portion 13 communicated with an upper end of the updrawing tube 20, and having the nozzle 14 protruded from a part of a peripheral side surface of the head portion; a contact pad 21 fitted on an outer periphery of a lower portion of the updrawing tube 20; a contact pad fixture member 22 inserted through a lower side portion of the contact pad 21 and through the inside of the updrawing tube 20; a coil spring 23 accommodated within a lower portion of the cylinder 19, so as to exert an upward spring force against the contact pad fixture member 22; and a ball 24 of a small diameter, arranged near a lower end of the coil spring 23 so as to open and close a lower hole of the cylinder 19.

In usage of the pump, the head portion 13 is downwardly pushed by a fingertip so that the updrawing tube 20 is downwardly moved integrally with the head portion 13 against the spring force of the coil spring 23. This causes the contact pad 21 to be downwardly moved in a state closely contacted with an inner peripheral surface of the cylinder 19, and causes the ball 24 to block the lower hole of the cylinder 19. At that time, the shampoo liquid within the cylinder 19 is caused to pass between the contact pad 21 and contact pad fixture member 22, to flow into the updrawing tube 20, and to be dispensed from the nozzle 14 via internal flow passage of the head portion 13, by virtue of a compressive force by the contact pad 21.

Next, the finger is released from the head portion 13. This causes the spring force of the coil spring 23 to be exerted to the contact pad fixture member 22 to push up the same, so that the contact pad 21 is upwardly moved in a state closely contacted with the inner peripheral surface of the cylinder 19. At this time, there is caused a negative pressure state within the cylinder 19. As a result, the ball 24 is sucked up into the cylinder 19 to bring the lower hole into an opened state through which the shampoo liquid within the container 11 is sucked up into the interior space of the cylinder 19.

Thereafter, the dispenser pump 12 allows a constant amount of shampoo liquid within the container 11 to be dispensed from the outlet of the nozzle 14 whenever the pushing manipulation of the head portion 13 is repeated by one hand.

The one-handed manipulation tool 10 of the embodiment 1 will be explained in detail, with reference to FIG. 1, FIG. 2, and FIG. 4 through FIG. 10.

The one-handed manipulation tool 10 shown in FIG. 1 and FIG. 2 comprises: a push base 26 fixed to the head portion 13 through a fixture member 25; two stays 27 erected from the push base 26; and a ceiling portion 28 laterally provided across tip end portions of the stays 27, respectively, to define an insertion space “a” for a finger between the ceiling portion 28 and the push base 26 cooperatively with both stays 27.

Both stays 27 are remainders present at both sides of a short column body, respectively, made of synthetic resin and having a lower side and an upper side corresponding to the push base 26 and ceiling portion 28, respectively, when the column body is formed with a through-hole (the insertion space “a”) drilled through the column body in a manner that the through-hole has an axis orthogonal to an axis of the column body.

The fixture member 25 is a cap formed at a lower portion of an outer periphery of the push base 26, and detachably fitted on the head portion 13. Protruded from a lower end portion of an outer peripheral plate of the fixture member 25 over the entire circumference thereof is an engagement portion 25a for engagement with the head portion 13. Formed at a part of the outer peripheral plate of the fixture member 25 is a cut-out 25b through which the nozzle 14 is inserted. The cut-out 25b has a concretely formed position in a circumferential direction of the outer peripheral plate, which is offset by 90 degrees in the circumferential direction of the fixture member 25, from one of finger insertion openings “b” arranged at both ends of the insertion space “a” for a thumb, respectively.

There will be explained a manner for using the one-handed manipulation tool 10 of the embodiment 1.

In using the pump by two hands, one hand is placed on an upper surface of the ceiling portion 28 to push down the one-handed manipulation tool 10 together with the head portion 13, and the shampoo liquid dispensed from the nozzle 14 is received by a palm of the other hand. In this way, the shampoo liquid can be dispensed in a manner of using two hands as usual.

Further, as shown in FIG. 2, in using the pump by one hand, a thumb of a right hand is inserted into the insertion space “a” through one of the insertion openings “b”. Next, the push base 26 is pushed down together with the head portion 13 by the thumb, to dispense the shampoo liquid from the nozzle 14. This improves a manipulation ability of the pump in using it by one hand, as compared with a conventional one-handed manipulation tool by which the nozzle 14 is to be clamped by and between two fingers and the head portion is pushed down by a back of the hand, for example. Moreover, there is not required any specific changeover manipulation of the nozzle even in case of changeover to a two-handed style or a one-handed style, unlike the conventional pump-assisted liquid container exhibiting the one-hand manipulation function. Further, the insertion space “a” is defined by erecting the pair of stays 27 between the push base 26 and ceiling portion 28. In this way, the stays 27 having cross-sectional areas smaller than wall-like segments are utilized to allow for definition of the insertion space “a” larger than utilizing wall-like segments. Furthermore, usage of two stays 27 brings about two insertion openings “b” for inserting a thumb into the insertion space “a”. This allows an orientation of a fingertip of a thumb relative to the pump to be increased to two, without limited to one.

Moreover, the fixture member 25 of the cap type is fixed to the head portion 13, by inserting the nozzle 14 through the cut-out 25b and engaging the engagement portion 25a with the lower portion of the outer periphery of the head portion 13. This enables the one-handed manipulation tool 10 to be readily fitted onto the head portion 13. As a result, the one-handed manipulation tool 10 is detached from the head portion 13 and can be reused, when the shampoo liquid within the container 11 is exhausted.

The present invention is not restricted to the one-handed manipulation tool 10 shown in FIG. 1 and FIG. 2. For example, it may be embodied in a one-handed manipulation tool 10A (FIG. 4) including a push base 26 and a ceiling portion 28 coupled by one stay 27 having a circular cross-section, and a one-handed manipulation tool 10B (FIG. 5) including a push base 26 and a ceiling portion 28 coupled by two stays 27, the stays 27 being separated from each other and each having a circular cross-section. Alternatively, the present invention may be embodied in: a one-handed manipulation tool 10C (FIG. 6(a) including a push base 26 and a ceiling portion 28 coupled by three stays 27 which are located at apexes of an equilateral triangle in a plan view, respectively, and have circular cross-sections, respectively; and a one-handed manipulation tool 10D (FIG. 6(b)) including a push base 26 and a ceiling portion 28 coupled by four stays 27 which are located at corners of a square in a plan view, respectively, and have circular cross-sections, respectively.

Furthermore, the present invention may be embodied in: a one-handed manipulation tool 10E (FIG. 7) including a push base 26 and a ceiling portion 28 coupled by two thin stays 27 which are separated from each other, for example; and a one-handed manipulation tool 10F (FIG. 8) including a push base 26 and a ceiling portion 28 coupled by two thin stays 27 which are separated from each other, and in which the push base 26 has a central part coupled to a central part of an upper plate of the fixture member 25 via turning pin 30 in a manner to be turnable within a horizontal plane. Next, the present invention may be embodied in: a one-handed manipulation tool 10G (FIG. 9) in a shape that one of the stays 27 of the one-handed manipulation tool 10 is excluded; and a one-handed manipulation tool 10H (FIG. 10) provided by coupling the push base 26 of the one-handed manipulation tool 10G to a central part of an upper plate of the fixture member 25 via turning pin 30 in a manner to be turnable within a horizontal plane.

In case of the one-handed manipulation tool 10G, there is protruded a curved portion 26a for preventing slippage of a thumb, at an end of the push base 26 opposite to the stay 27 side. In turn, the one-handed manipulation tool 10H includes, on an upper surface of the push base 26, an antislipping sheet 31 having a fine lattice-like groove texture applied to a whole surface of the antislipping sheet. Instead of the antislipping sheet 31, it is possible to adopt an antislipping sheet 31A formed with fine convexes over its whole surface, or an antislipping sheet 31B formed with many fine and parallel grooves over its whole surface. Provision of these antislipping structures (curved portion 26a, antislipping sheets 31, 31A, 31B) allows prevention of slippage of a thumb relative to the surface of each push base 26 upon usage of the associated pump.

Further, in case of the one-handed manipulation tools 10F, 10H, since each push base 26 is fixed to the associated fixture member 25 in a manner turnable about the associated turning pin 30, it is possible to change an orientation of an axial direction of the associated insertion space “a” for a thumb to a direction for facilitating insertion of the thumb into the pertinent insertion opening “b”, by turning the push base 26 by an appropriate angle about the turning pin 30 even when it is initially difficult to insert the thumb into the insertion space “a” due to an insertion angle into the applicable insertion opening “b” upon usage of the pump by two hands or one hand.

1. A one-handed manipulation tool for a pump-assisted liquid container, fitted on a head portion of a dispenser pump for dispensing a predetermined amount of liquid contained within the container, to thereby allow for, by one hand, simultaneous execution of both a pumping manipulation of the dispenser pump, and a liquid receiving manipulation for receiving the liquid dispensed from a nozzle protruded from the head portion by a palm of the hand,
wherein the one-handed manipulation tool comprises:
a fixture member having an outer peripheral plate formed with: an engagement portion for engaging with the head portion; and a cut-out through which the nozzle is inserted; at portions of said outer peripheral plate, respectively;
a push base fixed to the head portion through said fixture member;
one or more stays erected from said push base; and
a ceiling portion provided at tip portions of the stays to define an insertion space for a finger between said ceiling portion and said push base cooperatively with said stays.

2. The one-handed manipulation tool for a pump-assisted liquid container of claim 1, wherein said push base is configured to be turnable relative to said fixture member, about an axis of an updrawing tube for updrawing the liquid within the container up to the head portion.
